(19) United States
(12) Patent Application Publication
(10) Pub. No.: US 2007/0125459 A1
(43) Pub. Date: Jun. 7, 2007

(54) Oxide cleaning and coating of metallic components

(75) Inventors: Bhupendra K. Gupta, Cincinnati, OH (US); Michael Howard Rucker, Cincinnati, OH (US); Wayne Ray Grady, Hamilton, OH (US); Ann Evans, Middletown, OH (US)

Correspondence Address: ADAMS EVANS P.A., 301 SOUTH TRYON STREET, SUITE 2180, TWO WACHOVIA CENTER, CHARLOTTE, NC, 28282-1991, US

(73) Assignee: General Electric Company, Schenectady, NY (US)

(21) Appl. No.: 11/296,165

(22) Filed: Dec. 7, 2005

(51) Int. Cl. B05D 3/02

(52) U.S. Cl. 148/535; 427/383.1

(57) ABSTRACT

A method of removing an oxide layer from a surface of a metallic component, includes: contacting the surface with an alkaline cleaner, followed by contacting the surface with an acidic solution. The method is especially useful for removing oxide layers from the interior of hollow gas turbine engine components. The cleaned surface may be provided with an oxide-resistant coating by a pack aluminide coating process.

### BACKGROUND OF THE INVENTION

This invention relates generally to repair and overhaul of metallic components and more particularly to removal of oxide layers from engine-run components.

Gas turbine components such as turbine nozzle segments are exposed during operation to a high temperature, corrosive gas stream, both externally and internally. Prior art turbine nozzles show excessive degradation in the internal passages due to oxidation and/or hot corrosion after multiple repairs, and service usage, as shown in FIG. 1. This situation primarily occurs when in new part manufacturing the internal passages are not coated by oxidation resistant aluminide coating. The wall degradation takes place from inside due to oxidation of the unprotected interior walls, and from outside by operations such as grit blasting, and gaseous treatment during various service repair operations. When the part wall thickness is excessively low (thin wall), the part has to be scrapped, resulting in added cost for long term engine maintenance. Because nozzle segments are complex in design, are made of relatively expensive materials, and are expensive to manufacture, it is generally desirable to extend their operating lives as long as possible. Vapor phase aluminiding (VPA) to apply aluminide coatings has been found to be ineffective to provide oxidation protection to internal passages, as aluminide vapors cannot reach inside stagnant internal surfaces. Furthermore, known types of internal coatings can not be effectively applied over an internal oxide layers in an engine-run component.

Accordingly, there is a need for a method of removing oxides from metallic components, especially the interior passages thereof.

### BRIEF SUMMARY OF THE INVENTION

The above-mentioned need is met by the present invention, which according to one aspect provides a method of removing an oxide layer from a surface of a metallic component, including: (a) contacting the surface with an alkaline cleaner adapted to modify the oxide to make it more easily removable without causing significant attack to the metallic component; (b) contacting the surface with an acidic solution adapted to remove the treated oxide without causing significant attack to the metallic component; and (c) repeating steps (a) and (b) in the order stated until a preselected amount of the oxide layer is removed.

According to another aspect of the invention, a method of coating an engine-run metallic component having at least one surface with an oxide layer thereupon includes: (a) contacting the surface with an alkaline cleaner adapted to modify the oxide to make it more easily removable without causing significant attack to the metallic component; (b) contacting the surface with an acidic solution adapted to remove the treated oxide without causing significant attack to the metallic component; (c) disposing a slurry comprising an aluminum source on the surface; (d) heating the component to transport aluminum from the slurry to the surface, thereby producing an aluminide coating on the surface; and (e) removing the residue of the slurry from the surface.

### BRIEF DESCRIPTION OF THE DRAWINGS

The invention may be best understood by reference to the following description taken in conjunction with the accompanying drawing figures in which:

FIG. 1 is a perspective view of a exemplary turbine nozzle;

FIG. 2 is a scanned image of a micrograph of a portion of an engine-run turbine component similar to the one shown in FIG. 1;

FIG. 3 is a scanned image of a micrograph of a portion of an engine-run turbine component after application of an aluminide coating according to a prior art method;

FIG. 4 is a scanned image of a micrograph of a portion of an engine-run turbine component after cleaning in accordance with the method described herein;

FIG. 5 is a scanned image of a micrograph of a portion of an engine-run turbine component after internal coating in accordance with the method described herein; and

FIG. 6 is a scanned image of a micrograph of an engine-run turbine airfoil after external coating in accordance with the method described herein;

### DETAILED DESCRIPTION OF THE INVENTION

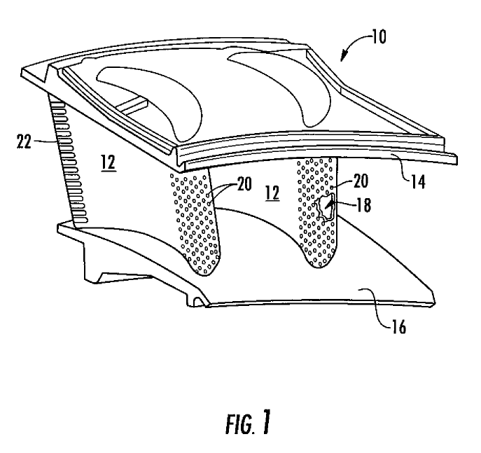

Referring to the drawings wherein identical reference numerals denote the same elements throughout the various views, FIG. 1 depicts a prior art turbine nozzle segment 10 having first and second nozzle vanes 12. It is noted that the present invention is equally applicable to other types of hollow metallic components, non-limiting examples of which include rotating turbine blades, internally cooled turbine shrouds, and the like. The vanes 12 are disposed between an arcuate outer band 14 and an arcuate inner band 16. The vanes 12 define airfoils configured so as to optimally direct the combustion gases to a turbine rotor (not shown) located downstream thereof. The outer and inner bands 14 and 16 define the outer and inner radial boundaries, respectively, of the gas flow through the nozzle segment 10. Each of the vanes 12 has a hollow interior cavity 18 disposed therein which receives relatively cool air to cool the vane. The spent cooling air is directed through exits such as cooling holes 20 and trailing edge slots 22. The nozzle segment 10 is typically made of a high quality superalloy, such as a cobalt or nickel-based superalloy, and may be coated with a corrosion resistant or “environmental” coating and/or a thermal barrier coating. Often, the interior cavities 18 are not coated with environmental coatings.

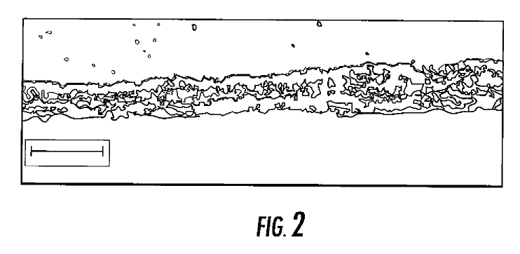

During engine operation, the interior cavities 18 are subjected to oxygen-rich, high-temperature, e.g. 538° C. (1000° F.) air flow, causing them to experience formation of oxides as shown in FIG. 2. This results in wall degradation from the inside. The presence of oxides also interferes with conventional methods of non-destructive evaluation (NDE) used for wall thickness measurement, such as ultrasonic inspection, because the oxide layer cannot be distinguished from the base material. When the part wall is too thin, the part has to be scrapped, resulting in added cost for long term engine maintenance.

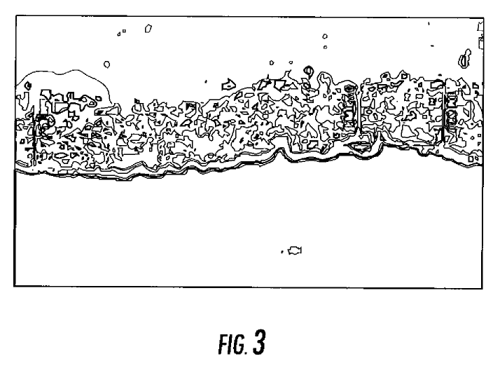

To stop further oxidation, it is desirable to apply a protective coating to the interior cavity 18. However, aluminide coatings applied over existing oxide layers exhibit a poor microstructure (see FIG. 3) which is prone to detachment and spalling and does not generally provide the desired level of protection.

The present invention provides a chemical cleaning sequence for removing these oxides, which begins by subjecting the interior cavity 18 to a scale conditioning cycle. The nozzle segment 10 is placed inside a cleaning. The working fluid for this first cycle is an alkaline cleaner which is capable of modifying oxide scale to make it more easily removable without causing significant attack to the base material of the nozzle segment 10. One example of a suitable alkaline cleaner is a 2-part liquid alkaline solution comprising sodium hydroxide and sodium permanganate, sold under the designation TURCO 4338, available from Henkel Surface Technologies, Madson Heights, Mich., 48071 USA. Other aggressive permanganate solutions may be substituted therefor. The alkaline cleaner is heated to an appropriate working temperature, for example about 80° C. (175° F.) to about 93° C. (200° F.). If desired, the nozzle segment 10 may be subjected to ultrasonic agitation during this cleaning cycle, using ultrasonic cleaning equipment of a known type. The cycle continues for a preselected time, for example about 30 minutes to about 60 minutes. The rate of depth penetration of the scale conditioning effect decays exponentially with time, and so extended treatment with the alkaline cleaner is neither necessary nor desirable. When the scale conditioning cycle is complete, the nozzle segment 10 is rinsed with water to remove any remaining alkaline cleaner.

The interior cavity 18 is then subjected to an oxide scale removal cycle. This may be done in the same cleaning tank or in a separate unit to speed the process. The working fluid for this second cycle is an acidic solution which is capable of removing the modified scale without causing significant attack to the base material of the nozzle segment 18. One example of a suitable acidic solution is an aqueous solution of 75% by volume nitric acid. Other suitable acids may include phosphoric acid, sulfuric acid, or hydrochloric acid. Unexpectedly, it has been found that a relatively high concentration of acid actually avoids pitting and attack on the base material of the nozzle segment 10 that may occur with lower concentrations of acid. While the precise acid concentration may be varied, base material attack is best avoided if the acid concentration is greater than about 25% by volume. The acidic solution is heated to an appropriate working temperature, for example about 77° C. (170° F.) to about 82° C. (180° F.). Ultrasonic agitation may optionally be applied as described above. It has been found that base material attack is best avoided if the temperature of the acid solution is greater than about 24° C. (75° F.). The cycle continues for a preselected time, for example about 30 minutes to about 60 minutes. The oxide layer is relatively rapidly removed to the depth at which it has been conditioned, and so extended treatment with the acidic solution is neither necessary nor desirable. When the scale removal cycle is complete, the nozzle segment 10 is rinsed with water to remove any remaining acidic solution.

The sequence of treatment in an alkaline cleaner followed by acidic solution is repeated as many times as necessary to remove the desired amount of the oxide build-up. Depending on the extent of oxide build-up, the chemical cleaning sequence may have to be repeated four times or more to remove the total oxide thickness. Using the process described, substantially all of the oxides may be removed without degradation of the base material, in contrast to mechanical methods or other chemical methods.

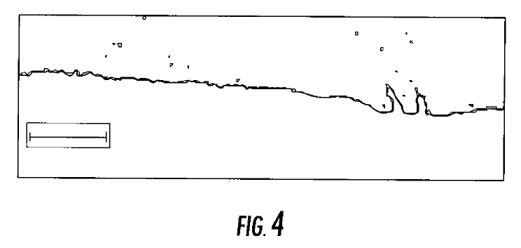

Once the chemical cleaning sequence is complete, substantially all of the oxide build-up will be removed from the interior cavity 18, as shown in FIG. 4. With the oxides removed, conventional NDE methods may be used for wall thickness measurement. The interior cavity 18 is also ready for subsequent coating.

The internal cleaning method described above will typically be performed at the same time the nozzle segment 10 is undergoing a repair cycle, either because of time-in-service limits, or external conditions that warrant overhaul. Therefore, other processes such as crack repair and renewal of external coatings will often be performed at the same time.

Where external coatings are to be applied (or re-applied), an appropriate exterior preparation process is carried out, for example a light grit blast with 240 grit media and about 207 kPA (30) to about 276 kPa (40 psi) air pressure. The exterior preparation process is controlled to assure that minimum amount of parent material is removed from the nozzle segment 10.

Next, a slurry for pack aluminide coating is prepared which includes a known type of powder mixture for producing an aluminide coating, and a binder. One suitable slurry consists essentially of, by weight, about 40% to about 80% of a powder mixture of an aluminum source, such as FeAl₂, FeAl₃, or Fe₂Al₅, and an inert material such as alumina, about 0.5% to about 1% of a carrier such as NH₄F, and the balance of a slurry-forming binder. Examples of suitable powder mixtures, slurries and coating techniques are described in U.S. Pat. No. 3,871,930 issued to Seybolt and assigned to the assignee of the present invention. This type of powder mixture and the coating process using this mixture have become known as a “CODAL” within the art.

The slurry is applied to the interior cavity 18 so that it is uniformly covered. Metallic tape or other masking materials are applied as needed to openings such as the cooling holes 20 and trailing edge slots 22, to assure that slurry remains in the internal cavity 18. The slurry is dried, either at room temperature or in a low-temperature, i.e. about 43° C. (110° F.), so that any water contained therein will not be driven out during the subsequent coating cycle. This reduces the risk of uneven coating application.

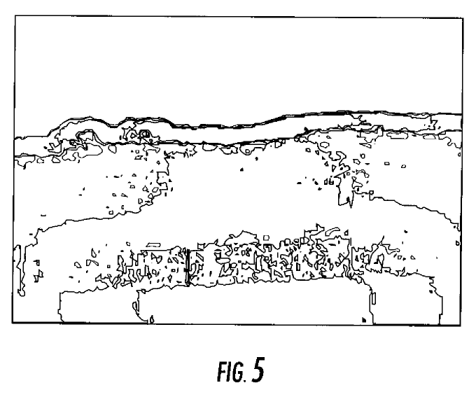

Once the slurry is dried, the nozzle segment 10 is ready for the internal coating cycle. This may be done by heating the nozzle segment 10 in a nonoxidizing atmosphere, e.g., a gas such as helium or argon, and typically in a vacuum, to a temperature of from about 500° C. (930° F.) to about 800° C. (1000° F.), to diffuse the aluminum into the substrate and form an aluminide coating on the interior surfaces of the nozzle segment 10. Depending on the temperature and composition of the nozzle segment 10, this coating cycle may occur over a wide range in time, e.g., from about 10 minutes to about 24 hours. The resulting coating is illustrated in FIG. 5.

Alternatively, the internal coating cycle may also be combined with a known vapor phase aluminide (VPA) coating process by heating the nozzle segment 10 in an oven or chamber containing an aluminide coating source material and provided with a nonoxidizing atmosphere at appropriate times and temperatures, for example about four hours at about 1080° C. (1975° F.).

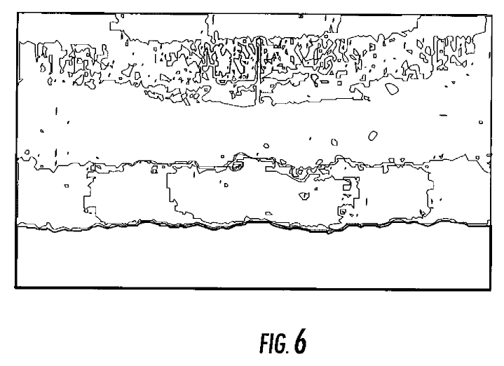

After the heating cycle or VPA cycle is complete, the interior cavity 18 is cleaned of inside passages of the residual slurry. The finished nozzle segment 10 has both internal and external oxidation-resistant coatings, as shown in FIG. 6. The microstructure of both the base material and the coatings are substantially the same as a new-make component, and the nozzle segment 10 will meet all of the metallurgical requirements of a new component.

The foregoing has described an oxide removal and coating process for metallic components. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation, the invention being defined by the claims.

What is claimed is:

1. A method of removing an oxide layer from a surface of a metallic component, comprising:
(a) contacting said surface with an alkaline cleaner adapted to modify said oxide to make it more easily removable without causing significant attack to the metallic component;
(b) contacting said surface with an acidic solution adapted to remove said treated oxide without causing significant attack to said metallic component; and
(c) repeating steps (a) and (b) in the order stated until a preselected amount of said oxide layer is removed.

2. The method of claim 1 where said component has at least one interior cavity which defines said surface.

3. The method of claim 2 wherein said component is a hollow turbine engine component including at least one airfoil.

4. The method of claim 1 wherein said alkaline cleaner comprises sodium permanganate.

5. The method of claim 1 wherein said alkaline cleaner comprises sodium hydroxide and sodium permanganate.

6. The method of claim 1 wherein said alkaline cleaner is maintained at a temperature of about 80 degrees Celsius to about 93 degrees Celsius during step (a).

7. The method of claim 1 wherein said acidic solution comprises, by volume, at least about 25% nitric acid.

8. The method of claim 1 wherein said acidic solution comprises, by volume, about 75% nitric acid.

9. The method of claim 1 wherein said acidic solution is maintained at a temperature of at least about 24 degrees Celsius during step (b).

10. The method of claim 1 wherein at least one of steps (a) and (b) includes ultrasonic agitation.

11. A method of coating an engine-run metallic component having at least one surface with an oxide layer thereupon, comprising:
(a) contacting said surface with an alkaline cleaner adapted to modify said oxide to make it more easily removable without causing significant attack to the metallic component;
(b) contacting said surface with an acidic solution adapted to remove said treated oxide without causing significant attack to said metallic component;
(c) disposing a slurry comprising an aluminum source on said surface;
(d) heating said component to transport aluminum from said slurry to said surface, thereby producing an aluminide coating on said surface; and
(e) removing the residue of said slurry from said surface.

12. The method of claim 11 where said component has at least one interior cavity, which defines said surface.

13. The method of claim 11 wherein said component is a gas turbine engine airfoil.

14. The method of claim 11 wherein said alkaline cleaner comprises sodium permanganate.

15. The method of claim 11 wherein said alkaline cleaner comprises sodium hydroxide and sodium permanganate.

16. The method of claim 11 wherein said alkaline cleaner is maintained at a temperature of about 80 degrees Celsius to about 93 degrees Celsius during step (a).

17. The method of claim 11 wherein said acidic solution comprises, by volume, at least about 25% nitric acid.

18. The method of claim 11 wherein said acidic solution comprises, by volume, about 75% nitric acid.

19. The method of claim 11 wherein said acidic solution is maintained at a temperature of at least about 24 degrees Celsius during step (b).

20. The method of claim 11 wherein at least one of steps (a) and (b) includes ultrasonic agitation.

21. The method of claim 11 wherein said slurry consists essentially of: an aluminum source, an inert material, a halide activator, and a binder.

22. The method of claim 6 wherein said step of heating said component is carried out as part of a vapor phase aluminiding coating process.
